(19) United States
(12) Patent Application Publication
(10) Pub. No.: US 2007/0299210 A1
(43) Pub. Date: Dec. 27, 2007

(54) Crosslinked lactam polymers

(76) Inventors: Ankur S. Kulshrestha, Jersey City, NJ (US); Kevin Cooper, Flemington, NJ (US); Walter R. Laredo, Hillsborough, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/472,667

(22) Filed: Jun. 22, 2006

(51) Int. Cl. C08F 126/10

(52) U.S. Cl. 525/326.9

(57) ABSTRACT

Crosslinked lactam polymers are disclosed. Specifically, lactam polymers having pendant acrylate groups are crosslinked via a Michael addition type acrylate reactant. The crosslinked lactam polymers are useful in medical and pharmaceutical applications.

### FIELD OF THE INVENTION

The present invention relates to crosslinked lactam polymers. More particularly, the present invention relates to crosslinked polymers derived from lactam polymers which have been functionalized with pendant acrylate groups.

### BACKGROUND OF THE INVENTION

Degradable crosslinked polymer networks are important in a number of biotechnological and medical applications such as drug delivery, tissue engineering, implantable devices, and in situ gelling materials. The presence of degradable linkages eliminates the need for long-term biocompatibility or surgical retrieval of the implanted polymer. Degradable networks are advantageous in tissue engineering, where a temporary scaffold is needed for structural support, cell attachment, and growth.

Poly(N-vinyl-2-pyrrolidone), also known as polyvinylpyrrolidone, PVP, Povidone, or Plasdone, is a water-soluble lactam polymer used commercially in such products as aerosol hair sprays, adhesives, lithographic solutions, pigment dispersions, and drug, detergent, and cosmetic formulations. The general class of lactam polymers, including PVP, are well known, as described for example in Robinson, B. V., Sullivan, F. M., Borzelleca, J. F., Schwartz, S. L.; “PVP: A Critical Review of the Kinetics and Toxicology of Polyvinylpyrrolidone (Povidone)”, 1990, Lewis Publishers, Inc., Chelsea, Mich.; U.S. Pat. Nos. 3,153,640, 2,927,913, 3,532,679; and Great Britain Patent number 811,135. PVP has been used extensively in medicine since 1939. The earliest use of PVP in medicine was during World War II when a 3.5% solution of PVP was infused into patients as a synthetic blood plasma volume expander. The toxicity of PVP, extensively studied in a variety of species including humans and other primates, is extremely low. PVP has also found use as internal wetting agents in contact lens applications.

The preparation of functionalized lactam polymers with pendant acrylate groups have been described in US Patent Publication 20060069235. In general, the '235 publication describes first treating lactam polymers with a reducing agent to form lactam polymers functionalized with hydroxyl groups. The hydroxyl-functionalized lactam polymers were then further functionalized with a hydroxyl reactive compound containing an acrylate group to form the acrylate-functionalized lactam polymers. More specifically, lactam polymers were dissolved in a protic solvent with a reducing agent and heated between 40° C. and 90° C. for up to two days. After purification by precipitation, the resultant hydroxyl-functionalized lactam polymer was then further functionalized with a hydroxyl-reactive compound containing an acrylate group, such as acryloyl chloride. In the case of acryloyl chloride, the acrylate-functionalized lactam polymer was prepared by the acryloylation of the hydroxyl groups on the hydroxyl-functionalized lactam polymer in an inert organic solvent containing an acid scavenger. The hydrochloride salt was removed by filtration and the polymer was recovered by removing the solvent by rotary evaporation. Lastly, the acrylate-functionalized lactam polymer was purified by precipitation.

The '235 publication also describes the preparation of crosslinked polymer hydrogels from acrylate-functionalized lactam polymers. The crosslinking reactions were accomplished through free radical polymerization. The free radical polymerization was initiated by using thermal initiators and heat or by using photo initiators and ultraviolet or visible light. The kinetics of free radical polymerization usually results in the formation of high molecular weight polymer chains. Although high molecular weight polymers may be useful for certain applications, such as in contact lenses, the high molecular weight chains generated by free radical polymerization may not be favorable for certain biomedical applications. The resultant polymer cannot be easily eliminated from the body due to its large hydrodynamic volume. For example, free radical polymerization of acrylate-functionalized lactam polymers will result in a crosslinked network containing polyacrylate segments covalently linked to the modified lactam polymer. The crosslinked network, when hydrolyzed, will give a lactam polymer of known molecular weight range (the same molecular weight of the starting lactam polymer). However, polyacrylic acid of various molecular weights is possible, including high MW. There is little control over the molecular weight of these chains without adding the additional complication of chain transfer agents. Additionally, for photopolymerized polymers, light attenuation by the initiator restricts the maximum attainable cure depth to a few millimeters. Therefore, photopolymerized polymers are not applicable to biomedical applications where the polymer or device needs to be more than just a few millimeters in thickness.

In view of the deficiencies in using free radical chemistry to crosslink a functionalized lactam polymer in certain biomedical applications such as, in implantable biodegradeable medical devices or in in situ polymerizable medical devices, it would be desirable to crosslink a lactam polymer using alternative chemistry.

### SUMMARY OF THE INVENTION

The invention is a crosslinked lactam polymer. The crosslinked lactam polymer comprises the reaction product of a) a lactam polymer which is functionalized with a pendant acrylate group, and b) a Michael Addition type acrylate reactant.

The crosslinked lactam polymers of this invention are particularly useful for medical and pharmaceutical applications. For example, in preferred embodiments of this invention, the polymers can be used for tissue augmentation, delivery of biologically active agents, hard tissue repair, hemostasis, adhesion prevention, tissue engineering applications, medical device coatings, adhesives and sealants, and the like.

### DETAILED DESCRIPTION OF THE INVENTION

The preparation of lactam polymers functionalized with pendant acrylate groups is described in US Patent Publication 20060069235. These functionalized lactam polymers are comprised of repeating units derived from substituted and unsubstituted lactam monomers in the polymer backbone. A percentage of the lactam repeating units is initially converted to secondary or tertiary hydroxy alkyl amines and subsequently to acrylates, which are randomly distributed throughout the polymer backbone.

Suitable lactam monomers include but are not limited to substituted and unsubstituted 4 to 7 membered lactam rings. Suitable substituents include but are not limited to C1-3 alkyl groups and aryl groups. Examples of suitable lactam monomers include N-vinyl lactams such as N-vinyl-2-pyrrolidinone, N-vinyl-2-piperidone, N-vinyl-epsilon-caprolactam, N-vinyl-3-methyl-2-pyrrolidone, N-vinyl-3-methyl-2-piperidone, N-vinyl-3-methyl-2-caprolactam, N-vinyl-4-methyl-2-pyrrolidone, N-vinyl-4-methyl-2-caprolactam, N-vinyl-5-methyl-2-pyrrolidone, N-vinyl-5-methyl-2-piperidone, N-vinyl-5,5-dimethyl-2-pyrrolidone, N-vinyl-3,3,5-trimethyl-2-pyrrolidone, N-vinyl-5-methyl-5-ethyl-2-pyrrolidone, N-vinyl-3,4,5-trimethyl-3-ethyl-2-pyrrolidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinylmaleimide, N-vinylsuccinimide, and mixtures thereof and the like.

Preferred lactam monomers are substituted and unsubstituted 4 to 6 membered lactam rings. Preferred lactam monomers are N-vinyl-2-pyrrolidinone, N-vinyl-2-piperidone, N-vinyl-epsilon-caprolactam, N-vinylsuccinimide, N-vinyl-3-methyl-2-pyrrolidone, and N-vinyl-4-methyl-2-pyrrolidone. More preferred lactam monomers are unsubstituted 4 to 6 membered lactam rings. More preferred lactam monomers are repeat units derived from N-vinyl-2-pyrrolidinone, N-vinyl-2-piperidone, N-vinyl-epsilon-caprolactam, and N-vinylsuccinimide. The most preferred lactam monomers are derived from N-vinyl-2-pyrrolidinone.

In addition to lactam monomers, the acrylate-functionalized lactam polymer may be comprised of repeat units derived from non-lactam monomers. Suitable non-lactam monomers include but are not limited to methyl methacrylate, methacrylic acid, styrene, butadiene, acrylonitrile, 2-hydroxyethyl methacrylate, acrylic acid, methyl acrylate, methyl methacrylate, vinyl acetate, N,N-dimethylacrylamide, N-isopropylacrylamide and poly(ethylene glycol) monomethacrylates, combinations thereof and the like. Preferred non-lactam monomers are methacrylic acid, acrylic acid, acetonitrile and mixtures thereof. A functionalized lactam polymer which is used for the preparation of the crosslinked lactam polymers of this invention ideally contains at least about 10% lactam repeat units, preferably at least about 30% lactam repeat units and more preferably at least about 50% lactam repeat units.

The acrylate-functionalized lactam polymers preferably have a number average molecular weight of at least about 1,000 Daltons. The preferred number average molecular weight of these acrylate-functionalized lactam polymers is greater than about 2,000 Daltons, more preferably between about 2,000 to about 300,000 Daltons, more preferably still between about 2,000 to about 100,000 Daltons, and most preferably between about 2,000 to about 40,000 Daltons.

Michael Addition type acrylate reactants can be di- or polyfunctional and are described generally in Lutolf, M. P; Tirelli, N.; Cerritelli, S.; Cavalli, L.; Hubbell, J. A. Bioconjugate Chem. 2001,12(6), 1051; U.S. Pat. No. 6,958,212; and Smith, M. B., March, J.; “March's Advanced Organic Chemistry Reactions, Mechanisms, and Structure, 5^{th} Edition”, 2001, pp. 1022-1024, John Wiley and Sons, Inc., New York, N.Y. There are also numerous reports on the preparation of chemically crosslinked, degradable hydrogels by Michael Addition of multifunctional thiol-containing compounds with end-functionalized polymers containing unsaturated groups such as PEG-diacrylates. See, for example, Lutolf, M. P; Hubbell, J. A. Biomacromolecules 2003,4(3),713; Lutolf, M. P; Tirelli, N.; Cerritelli, S.; Cavalli, L.; Hubbell, J. A. Bioconjugate Chem. 2001,12(6), 1051; Vernon, B.; Tirelli, N.; Bachi, T.; Haldimann, D.; Hubbell, J. A. J Biomed Mater Res Part A 2003, 64A, 447.

The preferred Michael Addition type acrylate reactant is an acrylate-reactive thiol. The preferred acrylate-reactive thiols include but are not limited to proteins containing cysteine residues, albumin, glutathione, 3,6-dioxa-1,8-octanedithiol (TCI America, Portland, Oreg.), oligo (oxyethylene) dithiols, pentaerythritol poly(ethylene glycol) ether tetra-sulfhydryl, Sorbitol poly(ethylene glycol) ether hexa-sulfhydryl (with a preferred molecular weight in the range of about 5,000 to 20,000, SunBio Inc., Orinda, Calif.), dimercaptosuccinic acid (Epochem Co. Ltd, Shangai, China), dihydrolipoic acid (HOOC—(CH2)4-CH(SH)—CH2-CH2SH, Geronova Research Inc., Reno, Nev.), dithiothreitol (HS—CH2-CH(OH)—CH(OH)—CH2SH, Sigma Aldrich Co., Milwaukee, Wis.), trimethylolpropane tris(3-mercaptopropionate) (Sigma Aldrich Co., Milwaukee, Wis.), pentaerythritol tetrathioglycolate, pentaerythritol tetra(3-mercaptopropionate), dipentaerythritol hexakis(thioglycolate) (DPHTG) (Austin Chemicals, Buffalo Grove, Ill.), and ethoxylated pentaerythritol (PP150) tetrakis(3-mercapto propionate) (Austin Chemicals, Buffalo Grove, Ill.). The more preferred acrylate-reactive thiols are pentaerythritol tetrathioglycolate, pentaerythritol tetra(3-mercaptopropionate), dipentaerythritol hexakis(thioglycolate) (DPHTG) (Austin Chemicals, Buffalo Grove, Ill.), and ethoxylated pentaerythritol (PP150) tetrakis(3-mercapto propionate) (Austin Chemicals, Buffalo Grove, Ill.). The most preferred acrylate-reactive thiol is ethoxylated pentaerythritol (PP150) tetrakis(3-mercapto propionate) (Austin Chemicals, Buffalo Grove, Ill.).

One of skill in the art will recognize that alternative Michael Addition type acrylate reactants may be used including but not limited to amines, enamines, nitriles, imidazole and its derivatives, acetoacetates, ketones, enolates, dithiocarbamate anions, and nitroalkanes.

The crosslinked lactam polymers of the present invention can be prepared by dispersing the acrylate-functionalized lactam polymer in the presence of a Michael Addition type acrylate reactant in a basic aqueous medium at a temperature between room temperature and 60 degrees Celsius, preferably between 25 and 40 degrees Celsius. The pH of the basic aqueous medium should be greater than 7, preferably in the range of about 7.5 to 11, more preferably in the range of about 8 to 10.5 and most preferably in the range of about 8.5 to about 10.5. The basic pH is provided by addition of an organic or inorganic base, and/or by inclusion of a buffer system that provides a pH in the desired range. Other chemical synthesis modifiers can be utilized to effect reactivity e.g., catalysts, activators, initiators, temperature or other stimuli. Various biocompatible solvents including, but not limited to, dimethyl sulfoxide, N-methyl-2-pyrrolidone, glycerol, triacetin, propylene glycol, water, TWEEN (Polysorbates) (ICI Americas Inc. Bridgewater, N.J.), poly(ethylene glycol)s, and combinations thereof may also be incorporated, if necessary in a 0.2 to 100-fold amount (by weight) of the co-reactants.

The most preferred crosslinked polymer reaction conditions are those in which the acrylate-functionalized lactam polymer is mixed with the Michael Addition type acrylate reactant in aqueous basic medium having a pH of about 8.5-10 and at a temperature of about 25-40 degrees Celsius.

It may be desirable, and in some cases essential, to use molar equivalent quantities of the reactants. In some cases, molar excess of a reactant may be added to compensate for side reactions such as reactions due to hydrolysis of the ester moiety.

It is also suitable to prepare the crosslinked polymers of the present invention in organic solvents, especially in the case where reactants are solids and not readily water-soluble or water dispersable. Aqueous solutions, organic solvents, poly(ethylene glycol)s, or aqueous-organic mixtures may also be added to improve the reaction speed or to adjust the viscosity of a given formulation.

The crosslinked polymers of the present invention can have various physical forms such as liquid, wax, solid, semi-solid, gels such as hydrogels, elastic solid, viscoelastic solid (like gelatin), a viscoelastic liquid that is formed of gel microparticles or even a viscous liquid of a considerably higher viscosity than any of the reactants when mixed together. The term “gel” refers to the state of matter between liquid and solid. As such, a “gel” has some of the properties of a liquid (i.e., the shape is resilient and deformable) and some of the properties of a solid (i.e., the shape is discrete enough to maintain three dimensions on a two dimensional surface.) The preferred physical forms are elastic solid or viscoelastic solid.

The crosslinked polymers of the present invention resulting from the reaction of the acrylate-functionalized lactam polymer and Michael Addition type acrylate reactant can be used in a variety of different pharmaceutical and medical applications. In general, the polymers described herein can be adapted for use in any medical or pharmaceutical application where polymers are currently being utilized. For example, the polymers of the present invention are useful as tissue sealants and adhesives, in tissue augmentation (i.e., fillers in soft tissue repair), in hard tissue repair such as bone replacement materials, as hemostatic agents, in preventing tissue adhesions (adhesion prevention), in providing surface modifications, in tissue engineering applications, intraocular lenses, contact lenses, coating of medical devices, and in drug/cell/gene delivery applications. One of skill in the art having the benefit of the disclosure of this invention will be able to determine the appropriate administration of a polymer composition of the present invention.

In one embodiment, the reactions of the present invention occur in situ, meaning they occur at local sites such as on organs or tissues in a living animal or human body. In another embodiment, the reactions do not release heat of polymerization that increases local temperature to more than 60 degrees Celsius. In yet another embodiment, any reaction leading to gelation occurs within 30 minutes; in still yet another embodiment within 15 minutes; and in still yet another embodiment within 5 minutes. Such polymers of the present invention form a gel that has sufficient adhesive and cohesive strength to become anchored in place. It should be understood that in some applications, adhesive and cohesive strength and gelling are not a prerequisite.

For the reactions of the present invention that occur in situ, the reactants utilized in the present invention are generally delivered to the site of administration in such a way that the reactants come into contact with one another for the first time at the site of administration, or immediately preceding administration. Thus, in one embodiment, the reactants of the present invention are delivered to the site of administration using an apparatus that allows the components to be delivered separately. Such delivery systems usually involve individualized compartments to hold the reactants separately with a single or multihead device that delivers, for example, a paste, a spray, a liquid, or a solid. The reactants of the present invention can be administered, for example, with a syringe and needle or a variety of devices. It is also envisioned that the reactants could be provided in the form of a kit comprising a device containing the reactants; the device comprising an outlet for said reactants, an ejector for expelling said reactants and a hollow tubular member fitted to said outlet for administering the reactants into an animal or human.

Alternatively, the reactants can be delivered separately using any type of controllable extrusion system, or they can be delivered manually in the form of separate pastes, liquids or dry powders, and mixed together manually at the site of administration. Many devices that are adapted for delivery of multi-component compositions are well known in the art and can also be used in the practice of the present invention.

Alternatively, the reactants of the present invention can be prepared in an inactive form as either a liquid or powder. Such reactants can then be supplied in a premixed form and activated after application to the site, or immediately beforehand, by applying an activator. In one embodiment, the activator is a buffer solution that will activate the formation of the crosslinked polymer once mixed therewith.

In another embodiment, for applications where the crosslinked polymer resulting from the reactants of the present invention need not be delivered to a site and formed in situ, the crosslinked polymer can be prepared in advance and take a variety of liquid or solid forms depending upon the application of interest as previously described herein.

Optional materials may be added to one more of the reactants to be incorporated into the resultant crosslinked polymers of the present invention, or may be separately administered. Optional materials include but are not limited to visualization agents, formulation enhancers, such as colorants, diluents, odorants, carriers, excipients, stabilizers or the like.

The reactants, and therefore the crosslinked polymers of the present invention, may further contain visualization agents to improve their visibility during surgical procedures. Visualization agents may be selected from among any of the various colored substances or dyes suitable for use in implantable medical devices, such as Food Drug & Cosmetic (FD&C) dyes number 3 and number 6, eosin, methylene blue, indocyanine green, or dyes normally found in synthetic surgical sutures. In one embodiment, the visualization agent is green, blue, or violet. The visualization agent may or may not become incorporated into the polymer. In one embodiment, the visualization agent does not have a functional moiety capable of reacting with the reactants of the present invention.

Additional visualization agents may be used such as fluorescent compounds (e.g., fluorescein, eosin, green or yellow fluorescent dyes under visible light), x-ray contrast agents (e.g., iodinated compounds) for visibility under x-ray imaging equipment, ultrasonic contrast agents, or magnetic resonance imaging (MRI) contrast agents (e.g., Gadolinium containing compounds).

The visualization agent may be used in small quantities, in one embodiment less than 1 percent (weight/volume); in another embodiment less that 0.01 percent (weight/volume); and in yet another embodiment less than 0.001 percent (weight/volume).

The examples below serve to further illustrate the invention, and should not be construed to limit the scope of the invention. The scope of the invention is defined by the appended claims. In the examples, unless expressly stated otherwise, amounts are by weight.

### EXAMPLES

### Example 1

### Synthesis of Hydroxyl Functionalized Polyvinylpyrrolidone (PVP-OH)

143 grams (1.29 moles) of polyvinylpyrrolidone (K25, MW about 30,000, Fluka, Milwaukee, Wis.) was dissolved in 888 grams of triethylene glycol (Aldrich, Milwaukee, Wis.) in a 4-liter beaker equipped with a mechanical stirring apparatus. 48.7 grams (1.29 moles) of sodium borohydride (VenPure AF granules, 98+%, Aldrich, Milwaukee, Wis.) was added to the PVP solution over a 1-hour period at room temperature. Substantial bubbling was observed. The reaction was heated to 110° C. and stirred for 5 hours. 500 milliliters of distilled water were added to the hot reaction mixture. The polymer was dialyzed against distilled water for 5 days and then against 2-propanol for 2 days using 1000 molecular weight cut-off dialysis membrane (Cellulose, Spectrum Laboratories, Rancho Dominguez, Calif.). The polymer was precipitated in hexanes:isopropyl ether (50:50 volume/volume) to yield a white solid having a number average molecular weight of 8,000 and weight average molecular weight of 24,500 (gel permeation chromatography, using hexafluoroisopropanol (HFIP) and poly(2-vinylpyridine) standards). The hydroxyl number (OH#) was determined by titration [OH#=53.4 milligrams potassium hydroxide/gram sample, hydroxyl equivalent weight (EW)=1,050 grams/mole].

### Synthesis of Acrylate Functionalized Polyvinylpyrrolidone (PVP-acrylate)

4.5 grams (41 millimoles of monomer units, 4.3 millimoles of OH) of the PVP-OH was dissolved in 250 milliliters of anhydrous N,N-dimethylacetamide in a 500 milliliter, 2 necked, round bottom flask equipped with a nitrogen inlet, rubber septum, and magnetic stirring bar. 0.39 grams (4.3 millimoles) of acryloyl chloride (Aldrich, Milwaukee, Wis.) and 10 milligrams of catechol (Aldrich, Milwaukee, Wis.) were added to the polymer solution. 1.3 grams (13 millimoles) of triethylamine (Fluka, Milwaukee, Wis.), were added and the reaction mixture was then stirred at 70° C. for 6 hours. The polymer solution was filtered to remove the hydrochloride salt and then precipitated three times from isopropyl ether to yield a solid polymer containing approximately 3 mole percent acrylate groups as confirmed by ¹H NMR spectroscopy shown in FIG. 1. ¹H NMR (CDCl₃) delta=6.41-6.29 (bm, 1H, acrylate vinyl), 6.13-6.01 (bm, 1H, acrylate vinyl), 5.85-5.66 (bm, 1H, acrylate vinyl), 4.18-3.44 (bm, 1H, PVP methine proton), 3.43-3.01 (bm, 2H, PVP), 2.49-1.28 (bm, 6H, PVP).

### Synthesis of First Crosslinked Polymer

451 milligrams of the PVP-acrylate was dissolved in 3.24 grams of borate buffer solution (pH=9.0, Fluka, Milwaukee, Wis.) in a 20-milliliter glass scintillation vial. 67 milligrams (55.8 micromoles) of ethoxylated pentaerythritol (PP150) tetrakis (3-mercaptopropionate) (Avg. MW=1201.5, FAO Austin Chemical Company Inc., Benseville, Ill.) was added to the reaction mixture at room temperature. The reaction mixture gelled within 1 minute forming a crosslinked hydrogel.

### Synthesis of Second Crosslinked Polymer

0.71 grams of the PVP-acrylate was dissolved in 1.6 grams of borate buffer solution (pH=9.0, Fluka, Milwaukee, Wis.) in a 5-milliliter glass vial. 69 milligrams (57.4 micromoles) of ethoxylated pentaerythritol (PP150) tetrakis(3-mercaptopropionate) (Avg. MW=1201.5, FAO Austin Chemical Company Inc., Benseville, Ill.) was added to the reaction mixture at room temperature and was shaken on a vortex stirrer. The reaction mixture gelled within 24 hours to form a crosslinked hydrogel.

### Synthesis of Third Crosslinked Polymer

0.33 grams of the PVP-acrylate was dissolved in 321 milligrams of borate buffer solution (pH=9.0, Fluka, Milwaukee, Wis.) in a 5-milliliter glass vial. 93 milligrams (77.6 micromoles) of ethoxylated pentaerythritol (PP150) tetrakis(3-mercaptopropionate) (Avg. MW=1201.5) was added to the reaction mixture at room temperature and was shaken on a vortex stirrer. The reaction mixture gelled within 2 hours to form a crosslinked hydrogel.

### Synthesis of Fourth Crosslinked Polymer

0.82 grams of PVP-acrylate from Example 1b was dissolved in 2.8 grams of borate buffer solution (pH=9.0, Fluka, Milwaukee, Wis.) in a 5-milliliter glass vial. 173 milligrams (144 micromoles) of ethoxylated pentaerythritol (PP150) tetrakis(3-mercaptopropionate) (Avg. MW=1201.5) was added to the reaction mixture at room temperature and was shaken on a vortex stirrer. The reaction mixture gelled overnight to form a crosslinked hydrogel.

### Example 2

### Synthesis of Hydroxyl Functionalized Polyvinylpyrrolidone (PVP-OH)

100 grams (0.90 millimoles) of polyvinylpyrrolidone (K30, average molecular weight of about 40,000, Fluka, Milwaukee, Wis.) was dissolved in 700 milliliters of 2-propanol (Aldrich, Milwaukee, Wis.) in a 4-liter beaker equipped with a mechanical stirring apparatus. 34 grams (0.90 moles) of sodium borohydride (VenPure AF granules, 98+%, Aldrich, Milwaukee, Wis.) was added to the PVP solution over a 1-hour period at room temperature. Substantial bubbling was observed. The reaction was heated to 50° C. and stirred for 16 hours. 500 milliliters of distilled water were added to the reaction mixture. The polymer was dialyzed against distilled water for 7 days, methyl alcohol for 2 days, and 2-propanol for 1 day using 1000 molecular weight cut-off dialysis membrane (Cellulose, Spectrum laboratories, Rancho Dominguez, Calif.). The polymer was precipitated in isopropyl ether:acetone (50:50 volume/volume) to yield a white solid with OH#=20.5 milligrams KOH/gram sample and hydroxyl equivalent weight (EW)=2,700 grams/mole.

### Synthesis of Acrylate Functionalized Polyvinylpyrrolidone (PVP-acrylate)

25.2 grams (227 millimoles of monomer units, 9.3 millimoles of OH) of the PVP— was dissolved in 308 grams of anhydrous 1,4-dioxane (Aldrich, Milwaukee, Wis.) in a 500 milliliter, 2 necked, round bottom flask equipped with a nitrogen inlet, rubber septum, and magnetic stirring bar. 1.67 grams (18.4 millimoles) of acryloyl chloride and 20 milligrams of hydroquinone (Aldrich, Milwaukee, Wis.) were added to the polymer solution. 5.60 grams (55.3 millimoles) of triethylamine was added and the reaction mixture was then stirred at 70° C. for 6 hours. The polymer solution was filtered to remove the hydrochloride salt and then precipitated three times from isopropyl ether to yield a solid polymer containing approximately 0.2-0.3 mole percent acrylate groups as confirmed by ¹H NMR spectroscopy. ¹H NMR (CDCl₃) delta=6.75-5.65 (bm, 3H, acrylate vinyls), 4.21-3.44 (bm, 1H, PVP methine proton), 3.43-2.80 (bm, 2H, PVP), 2.65-0.60 (bm, 6H, PVP).

### Synthesis of Crosslinked Polymer

2.54 grams of the PVP-acrylate was dissolved in 4.43 grams of borate buffer solution (pH=9.0, Fluka, Milwaukee, Wis.) in a 20-milliliter glass scintillation vial. 323 milligrams (269 micromoles) of ethoxylated pentaerythritol (PP150) tetrakis (3-mercaptopropionate) (Avg. MW=1201.5) was added to the reaction mixture at room temperature. The reaction mixture gelled within 24 hours at room temperature forming a crosslinked hydrogel.

### Synthesis of Crosslinked Polymer Containing Pemirolast(a Mast Cell Stabilizer)

2.0 grams of the PVP-acrylate was dissolved in 3.1 grams of borate buffer solution (pH=9.0, Fluka, Milwaukee, Wis.), 2.0 grams propylene glycol (Aldrich, Milwaukee, Wis.), and 1.8 g N-methyl-2-pyrrolidone (Aldrich, Milwaukee, Wis.) in a 20 mL glass scintillation vial. 109 mg (475 mmoles) of Pemirolast (mast cell stabilizer) (Dipharma S.p.A., Milano, Italy) and 501 milligrams (417 micromoles) of ethoxylated pentaerythritol (PP150) tetrakis (3-mercaptopropionate) (PP150-TMP) (Avg. MW=1201.5) were added to the reaction mixture at room temperature. The reaction mixture was shaken for 2 minutes using a vortex mixer and then poured into a 70 millimeter diameter aluminum dish. The film gelled within 30 minutes at room temperature.

### In Vitro Release of Pemirolast From Crosslinked Polymer

After 6.5 hours of adding PP150-TMP to the reaction mixture as described above, a portion of the crosslinked film (7.58 grams, 2.5 millimeters in thickness) was placed in 370 milliliters phosphate buffer solution (pH 7.4, Sigma-Aldrich, Milwaukee, Wis.). A 2.5 milliliter aliquot was removed at each time point and replaced with 2.5 milliliters fresh buffer solution. Pemirolast release was quantified via UV/VIS spectroscopy (lambda max=256 nanometers) and the corresponding release profile is shown in Table 1.

TABLE 1

| | | Cumulative | |
|---|---|---|---|
| | | Pemirolast Release | |
| Entry # | Time (hr) | (mg) | Wt. % Release |
| 1 | 0.19 | 10 | 12 |
| 2 | 0.39 | 19 | 21 |
| 3 | 0.62 | 25 | 28 |
| 4 | 1.3 | 43 | 49 |
| 5 | 2.5 | 59 | 68 |
| 6 | 17 | 82 | 95 |

### Synthesis of Crosslinked Polymer Containing Lidocaine

1.44 grams of the PVP-acrylate was dissolved in 3.0 grams of borate buffer solution (pH=9.0, Fluka, Milwaukee, Wis.), 1.4 grams of glycerol (Aldrich, Milwaukee, Wis.), 0.46 grams of propylene glycol, and 2.1 grams of N-methyl-2-pyrrolidone in a 20 milliliter glass scintillation vial. 251 milligrams (1.07 millimoles) of Lidocaine (Sigma, Milwaukee, Wis.) and 329 milligrams (274 micromoles) of ethoxylated pentaerythritol (PP150) tetrakis (3-mercaptopropionate) (Avg. MW=1201.5) were added to the reaction mixture at room temperature. The reaction mixture was shaken for 2 minutes using a vortex mixer and then poured into a 70 millimeter diameter aluminum dish. The thick film gelled within 30 minutes at room temperature.

### In Vitro Release of Lidocaine From Crosslinked Polymer

After 3.1 hours of adding PP150-TMP to the reaction mixture described above, a portion of the crosslinked film (0.98 grams, 2.5 millimeters in thickness) was placed in 20.0 milliters phosphate buffer solution (pH 7.4, Sigma-Aldrich, Milwaukee, Wis.). A 2.5 millilter aliquot was removed at each time point and replaced with 2.5 millliliters fresh buffer solution. Lidocaine release was quantified via UV/VIS spectroscopy (lambda max=262 nanometers) and the corresponding release profile is shown in Table 2.

TABLE 2

| | | Cumulative | |
|---|---|---|---|
| | | Lidocaine Release | Wt. % Lidocaine |
| Entry # | Time (hr) | (mg) | Release |
| 1 | 0.15 | 1.6 | 5.8 |
| 2 | 0.33 | 4.7 | 17 |
| 3 | 0.49 | 8.6 | 32 |
| 4 | 0.66 | 10 | 37 |
| 5 | 0.84 | 12 | 43 |
| 6 | 1.0 | 13 | 46 |
| 7 | 1.6 | 16 | 58 |
| 8 | 2.2 | 18 | 67 |
| 9 | 2.9 | 21 | 76 |
| 10 | 4.5 | 25 | 90 |
| 11 | 5.6 | 27 | 97 |

### Example 3

### Synthesis of Hydroxyl Functionalized Polyvinylpyrrolidone (PVP-OH)

497 grams (4.47 moles) of polyvinylpyrrolidone (K15, average molecular weight of about 10,000, Fluka, Milwaukee, Wis.) was dissolved in 3 liters distilled water in a 4-liter beaker equipped with a mechanical stirring apparatus. 360 grams (9.5 moles) of sodium borohydride (powder, 98+%, Aldrich, Milwaukee, Wis.) was slowly added to the PVP solution over a 3-hour period at room temperature. Substantial bubbling was observed. The reaction was heated to 70° C. and stirred for 24 hours. Concentrated HCl (Fisher Scientific, Pittsburgh, Pa.) was added to lower the pH from 11 to 7. The polymer was dialyzed against distilled water for 10 days using 500 molecular weight cut-off dialysis membrane (Cellulose, Spectrum Laboratories, Rancho Dominguez, Calif.). The water was removed by rotary evaporation to yield a white solid with OH#=33.3 mg KOH/gram sample and hydroxyl equivalent weight (EW)=1,680 grams/mole.

### Synthesis of Acrylate Functionalized Polyvinylprrolidone (PVP-acrylate)

32.3 grams (291 millimoles of monomer units, 19 millimoles of OH) of the PVP-OH was dissolved in 400 milliliters of anhydrous N,N-dimethylformamide (Aldrich, Milwaukee, Wis.) and 10 milliliters anhydrous pyridine (Aldrich, Milwaukee, Wis.) in a 500 milliliter, 2 necked, round bottom flask equipped with a nitrogen inlet, rubber septum, and magnetic stirring bar. 3.48 grams (38.4 millimoles) of acryloyl chloride, 100 milligrams 4-(dimethylamino)pyridine (0.82 millimoles) (Aldrich, Milwaukee, Wis.) and 20 milligrams of hydroquinone were added to the polymer solution. The reaction mixture was then stirred at 100° C. for 1 hour. The polymer solution was filtered to remove the hydrochloride salt and then precipitated three times from isopropyl ether to yield a solid polymer containing approximately 4-5 mole percent acrylate groups as confirmed by ¹H NMR spectroscopy. ¹H NMR (D₂O) delta=6.39-6.21 (bm, 1H, acrylate vinyl), 6.18-5.96 (bm, 1H, acrylate vinyl), 5.95-5.82 (bm, 1H, acrylate vinyl), 4.01-3.42 (bm, 1H, PVP methine proton), 3.41-2.95 (bm, 2H, PVP), 2.50-1.10 (bm, 6H, PVP).

### Synthesis of Crosslinked Polymer

2.29 grams of the PVP-acrylate was dissolved in 3.17 grams of borate buffer solution (pH=9.0) in a 20 milliliter glass scintillation vial. 650 milligrams (541 micromoles) of ethoxylated pentaerythritol (PP150) tetrakis (3-mercaptopropionate) (Avg. MW=1201.5) was added to the reaction mixture at room temperature. After 2 minutes of vortexing at room temperature the reaction mixture was poured between 2 parallel plates (diameter=40 mm). Rheology data was acquired on a Rheometrics RDA-II Rheometer using a single point dynamic time sweep test. The reaction mixture gelled within 24 hours at room temperature forming a crosslinked hydrogel.

### Example 4

### Synthesis of Acrylate Functionalized Polyvinylpyrrolidone (PVP-acrylate)

6.7 grams (60 millimoles of monomer units, 4 millimoles of OH) of the PVP-OH from Example 3 was dissolved in 400 milliliters of anhydrous 1,4-dioxane in a 500 milliliter, 2 necked, round bottom flask equipped with a nitrogen inlet, rubber septum, and magnetic stirring bar. 1.1 grams (12 millimoles) of acryloyl chloride and 3.6 grams triethylamine were added dropwise in this order. 100 milligrams of hydroquinone was added to the polymer solution and the reaction mixture was then stirred at 55° C. for 6 hours. The polymer solution was filtered to remove the hydrochloride salt and then precipitated three times from isopropyl ether:hexanes (50/50 volume/volume) to yield a solid polymer containing approximately 5-6 mole percent acrylate groups as confirmed by ¹H NMR spectroscopy. ¹H NMR (D₂O) delta=6.39-6.21 (bm, 1H, acrylate vinyl), 6.18-5.96 (bm, 1H, acrylate vinyl), 5.95-5.82 (bm, 1H, acrylate vinyl), 4.01-3.42 (bm, 1H, PVP methine proton), 3.41-2.95 (bm, 2H, PVP), 2.50-1.10 (bm, 6H, PVP).

### Synthesis of Crosslinked Polymer

1.0 gram of the PVP-acrylate was dissolved in 2 grams of borate buffer solution (pH=10.0) and 2 grams of N-methyl-2-pyrrolidone in a 2-dram glass vial. 133 milligrams (111 micromoles) of ethoxylated pentaerythritol (PP150) tetrakis (3-mercaptopropionate) (Avg. MW=1201.5) was added to the reaction mixture at ambient temperature. The reaction mixture gelled within 30 minutes at ambient temperature forming a crosslinked hydrogel.

We claim:

1. A crosslinked lactam polymer comprising the reaction product of a) a lactam polymer having a pendant acrylate group, and b) a Michael addition type reactant.

2. The crosslinked lactam polymer of claim 1 wherein the lactam polymer comprises repeat units derived from lactam monomers selected from the group consisting of N-vinyl-2-pyrrolidinone, N-vinyl-2-piperidone, N-vinyl-epsilon-caprolactam, N-vinyl-3-methyl-2-pyrrolidone, N-vinyl-3-methyl-2-piperidone, N-vinyl-3-methyl-2-caprolactam, N-vinyl-4-methyl-2-pyrrolidone, N-vinyl-4-methyl-2-caprolactam, N-vinyl-5-methyl-2-pyrrolidone, N-vinyl-5-methyl-2-piperidone, N-vinyl-5,5-dimethyl-2-pyrrolidone, N-vinyl-3,3,5-trimethyl-2-pyrrolidone, N-vinyl-5-methyl-5-ethyl-2-pyrrolidone, N-vinyl-3,4,5-trimethyl-3-ethyl-2-pyrrolidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinylmaleimide, N-vinylsuccinimide and combinations thereof.

3. The crosslinked lactam polymer of claim 2 wherein the lactam polymer comprises repeat units derived from lactam monomers selected from the group consisting of N-vinyl-2-pyrrolidinone, N-vinyl-2-piperidone, N-vinyl-epsilon-caprolactam, N-vinylsuccinimide, N-vinyl-3-methyl-2-pyrrolidone, and N-vinyl-4-methyl-2-pyrrolidone and combinations thereof.

4. The crosslinked lactam polymer of claim 3 wherein the lactam polymer comprises repeat units derived from lactam monomers selected from the group consisting of N-vinyl-2-pyrrolidinone, N-vinyl-2-piperidone, N-vinyl-epsilon-caprolactam, and N-vinylsuccinimide and combinations thereof.

5. The crosslinked lactam polymer of claim 4 wherein the lactam polymer comprises repeat units derived from N-vinyl-2-pyrrolidinone.

6. The crosslinked lactam polymer of claim 2 wherein the Michael addition type reactant is an acrylate reactive thiol selected from the group consisting of proteins containing cysteine residues, albumin, glutathione, 3,6-dioxa-1,8-octanedithiol, oligo(oxyethylene)dithiols, pentaerythritol poly(ethylene glycol)ether tetra-sulfhydryl, sorbitol poly(ethylene glycol)ether hexa-sulfhydryl, dimercaptosuccinic acid, dihydrolipoic acid, dithiothreitol, trimethylolpropane tris(3-mercaptopropionate), pentaerythritol tetrathioglycolate, pentaerythritol tetra(3-mercaptopropionate)dipentaerythritol hexakis(thioglycolate), and ethoxylated pentaerythritol (PP150) tetrakis(3-mercapto propionate) and combinations thereof

7. The crosslinked lactam polymer of claim 3 wherein the Michael addition type reactant is an acrylate reactive thiol selected from the group consisting of pentaerythritol tetrathioglycolate, pentaerythritol tetra(3-mercaptopropionate), dipentaerythritol hexakis(thioglycolate), and ethoxylated pentaerythritol (PP150) tetrakis(3-mercapto propionate) and combinations thereof.

8. The crosslinked lactam polymer of claim 4 wherein the Michael addition type reactant is an acrylate reactive thiol selected from the group consisting of pentaerythritol tetrathioglycolate, pentaerythritol tetra(3-mercaptopropionate), dipentaerythritol hexakis(thioglycolate), and ethoxylated pentaerythritol (PP150) tetrakis(3-mercapto propionate) and combinations thereof.

9. The crosslinked lactam polymer of claim 5 wherein the Michael addition type reactant is ethoxylated pentaerythritol (PP150) tetrakis(3-mercapto propionate).

10. The crosslinked lactam polymer of claim 6 wherein the lactam polymer further comprises repeat units from a non-lactam monomer selected from the group consisting of methyl methacrylate, methacrylic acid, styrene, butadiene, acrylonitrile, 2-hydroxyethyl methacrylate, acrylic acid, methyl acrylate, methyl methacrylate, vinyl acetate, N,N-dimethylacrylamide, N-isopropylacrylamide and poly(ethylene glycol)monomethacrylates, and combinations thereof.

11. The crosslinked lactam polymer of claim 7 wherein the lactam polymer further comprises repeat units from a non-lactam monomer selected from the group consisting of methacrylic acid, acrylic acid, acetonitrile and combinations thereof.

12. The crosslinked lactam polymer of claim 8 wherein the lactam polymer further comprises repeat units from a non-lactam monomer selected from the group consisting of methacrylic acid, acrylic acid, acetonitrile and combinations thereof.

13. The crosslinked lactam polymer of claim 9 wherein the lactam polymer further comprises repeat units from a non-lactam monomer selected from the group consisting of methacrylic acid, acrylic acid, acetonitrile and combinations thereof.
